(19) United States
(12) Patent Application Publication
(10) Pub. No.: US 2022/0029744 A1
(43) Pub. Date: Jan. 27, 2022

(54) CONTROL DEVICE, COMMUNICATION DEVICE, AND SYSTEM

(71) Applicant: KABUSHIKI KAISHA TOKAI RIKA DENKI SEISAKUSHO, Aichi (JP)

(72) Inventors: Kazuki NAIKI, Aichi (JP); Kenichi KOGA, Aichi (JP)

(73) Assignee: KABUSHIKI KAISHA TOKAI RIKA DENKI SEISAKUSHO, Aichi (JP)

(21) Appl. No.: 17/346,788

(22) Filed: Jun. 14, 2021

(30) Foreign Application Priority Data
Jul. 27, 2020 (JP) 2020-126285

(51) Int. Cl. H04L 1/08; H04W 4/48

(52) U.S. Cl. CPC H04L 1/08; H04W 4/48

(57) ABSTRACT

Retry related to wireless communication is realized more efficiently.

A control device includes a wireless communication unit that has at least two antenna elements and performs wireless communication with another communication device, and a control unit that controls a control target device on the basis of a direction of the other communication device that is estimated by using the wireless communication, in which the control unit determines whether or not retry of the wireless communication is necessary on the basis of a status in which the wireless communication unit receives a signal from the other communication device.

### CROSS REFERENCE TO RELATED APPLICATION(S)

This application is based upon and claims benefit of priority from Japanese Patent Application No. 2020-126285, filed on Jul. 27, 2020, the entire contents of which are incorporated herein by reference.

### BACKGROUND

The present invention relates to a control device, a communication device, and a system.

In recent years, a technique of performing authentication according to results of transmission and reception of signals between devices has been developed. For example, Japanese Unexamined Patent Application Publication No. 11-208419 discloses a system that performs authentication of a portable device by transmitting and receiving signals between an in-vehicle device and the portable device and thus controls a vehicle according to a result of the authentication.

### SUMMARY

However, in the above system, even when the in-vehicle device and the portable device are in a regular combination, there is a case where authentication may not be established depending on communication statuses.

Therefore, the present invention has been made in light of the above problem, and an object of the present invention is to more efficiently realize retry related to wireless communication.

In order to solve the above problem, according to an aspect of the present invention, there is provided a control device including a wireless communication unit that has at least two antenna elements and performs wireless communication with another communication device; and a control unit that controls a control target device on the basis of a direction of the other communication device that is estimated by using the wireless communication, in which the control unit determines whether or not retry of the wireless communication is necessary on the basis of a status in which the wireless communication unit receives a signal from the other communication device.

In order to solve the above problem, according to another aspect of the present invention, there is provided a communication device that is carried by a user and performs wireless communication with another device, the communication device including a wireless communication unit that performs the wireless communication; a state detection unit that detects a state of the communication device; a notification unit that provides a notification to the user; and a control unit that controls retry of the wireless communication on the basis of a retry request transmitted from the other device, in which the control unit causes the notification unit to output a notification for prompting the user to improve a state of the communication device in a case where the wireless communication unit has received the retry request, and instructs the wireless communication unit to retry the wireless communication in a case where the state detection unit detects that the state of the communication device has transitioned to a defined state appropriate for the wireless communication.

In order to solve the above problem, according to still aspect of the present invention, there is provided a system including a control device; and a communication device, in which the control device includes a first wireless communication unit that has at least two antenna elements and performs wireless communication with the communication device, and a first control unit that controls a control target device on the basis of a direction of the communication device that is estimated by using the wireless communication, in which the first control unit determines whether or not retry of the wireless communication is necessary on the basis of a status in which the first wireless communication unit receives a signal from the communication device, in which the communication device includes a second wireless communication unit that performs the wireless communication with the control device, a state detection unit that detects a state of the communication device, a notification unit that provides a notification to a user, and a second control unit that controls retry of the wireless communication on the basis of a retry request transmitted from the control device, and in which the second control unit causes the notification unit to output a notification for prompting the user to improve a state of the communication device in a case where the second wireless communication unit has received the retry request, and instructs the second wireless communication unit to retry the wireless communication in a case where the state detection unit detects that the state of the communication device has transitioned to a defined state appropriate for the wireless communication.

As described above, according to the present invention, it is possible to more efficiently realize retry related to wireless communication.

### BRIEF DESCRIPTION OF THE DRAWINGS

FIG. 1 is a block diagram illustrating a configuration example of a system 1 according to the present embodiment related to an embodiment of the present invention.

FIG. 2 is a diagram for describing an example of control for a control target device in an in-vehicle device 20 according to the same embodiment.

FIG. 3 is a sequence diagram illustrating an example of a flow of control for a control target device in the system 1 according to the same embodiment.

FIG. 4 is a sequence diagram illustrating an example of a flow of retry control in the system 1 according to the same embodiment.

### DETAILED DESCRIPTION OF THE EMBODIMENT

Hereinafter, referring to the appended drawings, preferred embodiments of the present invention will be described in detail. It should be noted that, in this specification and the appended drawings, structural elements that have substantially the same function and structure are denoted with the same reference numerals, and repeated explanation thereof is omitted.

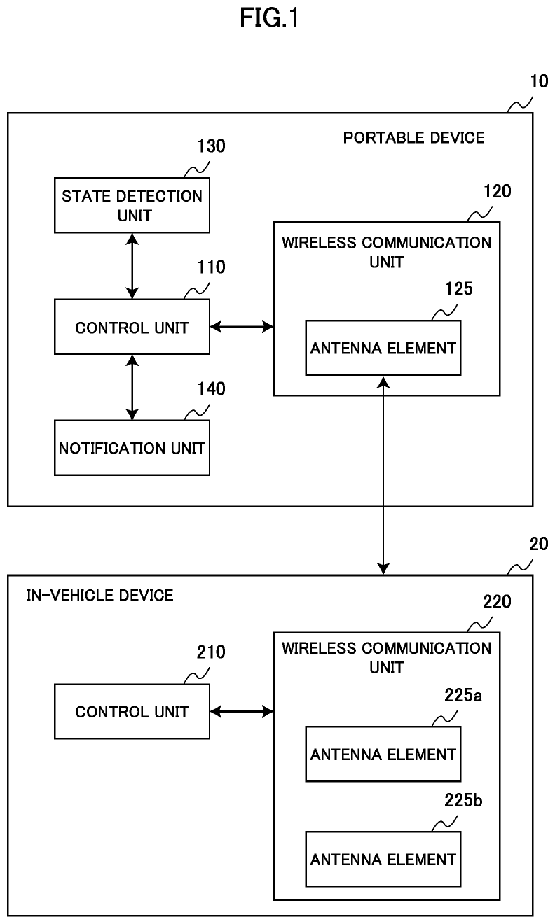

First, a configuration example of a system 1 according to an embodiment of the present invention will be described. FIG. 1 is a block diagram illustrating a configuration example of the system 1 according to the present embodiment. As illustrated in FIG. 1, the system 1 according to the present embodiment includes a portable device 10 and an in-vehicle device 20.

### Portable Device 10

The portable device 10 according to the present embodiment is a communication device carried by a user of a moving object having the in-vehicle device 20 mounted therein. The portable device 10 according to the present embodiment may be, for example, a smartphone or a dedicated device.

As illustrated in FIG. 1, the portable device 10 according to the present embodiment includes a control unit 110, a wireless communication unit 120, a state detection unit 130, and a notification unit 140.

### Control Unit 110

The control unit 110 according to the present embodiment controls each constituent of the portable device 10. The control unit 110 may perform distance measurement for calculating a distance between the portable device 10 and the in-vehicle device 20 (more specifically, a distance between the wireless communication unit 120 and a wireless communication unit 220 of the in-vehicle device 20) on the basis of a result of wireless communication performed between the wireless communication unit 120 and the in-vehicle device 20.

For example, the control unit 110 according to the present embodiment may perform the distance measurement on the basis of a first signal transmitted from the wireless communication unit 120 and a second signal transmitted from the in-vehicle device 20 as a response to the first signal.

More specifically, the control unit 110 performs the distance measurement on the basis of a time period ΔT1 between a time point at which the wireless communication unit 120 transmits the first signal and a time point at which the wireless communication unit 120 receives the second signal and a time period ΔT2 between a time point at which the in-vehicle device 20 receives the first signal and a time point at which the in-vehicle device 20 transmits the second signal.

The control unit 110 may calculate a time period required for round-trip communication of the distance measurement signals by subtracting ΔT2 from ΔT1, or may calculate a time required for one-way communication of the distance measurement signals by dividing the time period by 2. The control unit 110 may multiply the value of (ΔT1-ΔT2)/2 by a velocity of the signal to obtain a distance (hereinafter, also referred to as a distance measurement value) between the portable device 10 and the in-vehicle device 20.

As the first signal and the second signal, signals using frequencies in an ultra-wide band (UWB) may be used. An impulse type signal based on the UWB has characteristics of being capable of performing positioning and distance measurement with high accuracy. In other words, a radio wave having a very short pulse width of nanoseconds or less is used such that the air propagation time of the radio wave can be measured with high accuracy, and positioning and distance measurement based on the propagation time can be performed with high accuracy.

The control unit 110 according to the present embodiment may control retry of wireless communication on the basis of a retry request transmitted from the in-vehicle device 20. In a case where the retry request is received by the wireless communication unit 120, the control unit 110 according to the present embodiment causes the notification unit 140 to output a notification for prompting a user to improve a state of the portable device 10. In a case where the state detection unit 130 detects that a state of the portable device 10 has transitioned to a defined state appropriate for wireless communication, the control unit 110 according to the present embodiment instructs the wireless communication unit 120 to retry wireless communication.

For example, in a case where a communication status is poor according to a state of the portable device 10 since the portable device 10 is being stored in a pocket or a bag such that it is in a shielded state, the control unit 110 may cause the wireless communication unit 120 to retransmit the first signal when the portable device 10 has transitioned to a defined state appropriate for the wireless communication.

Transition to a defined state appropriate for the wireless communication may include, for example, the portable device 10 being taken out of a pocket, a bag, or the like and being brought into a state close to horizontal.

According to the above control, the first signal can be retransmitted at a timing at which the portable device 10 is brought into the defined state appropriate for the wireless communication such that unnecessary retry can be avoided in a poor communication status, and thus it is possible to more efficiently realize retry related to the wireless communication.

The functions of the control unit 110 according to the present embodiment are realized by various processors.

### Wireless Communication Unit 120

The wireless communication unit 120 according to the present embodiment performs wireless communication with the in-vehicle device 20. For this, the wireless communication unit 120 according to the present embodiment includes at least one antenna element 125.

For example, the wireless communication unit 120 according to the present embodiment transmits the first signal and receives the second signal. The wireless communication unit 120 transmits a distance measurement value calculated by the control unit 110 to the in-vehicle device 20.

The wireless communication unit 120 according to the present embodiment retries wireless communication with the in-vehicle device 20 under the control of the control unit 110. Specifically, the wireless communication unit 120 may retransmit the first signal under the control of the control unit 110.

### State Detection Unit 130

The state detection unit 130 according to the present embodiment detects a state of the portable device 10.

For example, the state detection unit 130 according to the present embodiment monitors a state of the portable device 10 under the control of the control unit 110, and inputs information indicating that the portable device 10 has transitioned to a defined state appropriate for wireless communication to the control unit 110.

For example, in a case where it is detected that the portable device 10 has been taken out of a pocket, a bag, or the like and brought into a state close to horizontal, the state detection unit 130 according to the present embodiment may input information indicating the fact to the control unit 110.

The state detection unit 130 according to the present embodiment may include an acceleration sensor in order to detect the above-described horizontal state. The state detection unit 130 may include an illuminance sensor in order to detect a shielded state and a non-shielded state. The state detection unit 130 may include, for example, a gyro sensor and a geomagnetic sensor other than the above sensors.

### Notification Unit 140

The notification unit 140 according to the present embodiment provides various notifications to a user under the control of the control unit 110.

For example, the notification unit 140 according to the present embodiment outputs a notification for prompting a user to improve a state of the portable device 10 under the control of the control unit 110.

The notification provided by the notification unit 140 may be, for example, an image including text, vocal sound, or defined vibration or light previously shared with a user.

For this, the notification unit 140 according to the present embodiment includes a display, a speaker, a vibration element, a light source, or the like.

As above, the functional configuration of the portable device 10 according to the present embodiment has been described. The above-described functional configuration of the portable device 10 is only an example, and the functional configuration of the portable device 10 according to the present embodiment is not limited to such an example. The functional configuration of the portable device 10 according to the present embodiment may be flexibly modified according to a specification or an operation.

### In-Vehicle Device 20

The in-vehicle device 20 according to the present embodiment is an example of a control device mounted in a moving object V such as a vehicle. As illustrated in FIG. 1, the in-vehicle device 20 according to the present embodiment includes a control unit 210 and a wireless communication unit 220.

### Control Unit 210

The control unit 210 according to the present embodiment controls each constituent of the in-vehicle device 20. The control unit 210 controls at least one control target device mounted in the moving object V.

The control unit 210 according to the present embodiment controls at least one control target device provided in the moving object V on the basis of a direction of the portable device that is estimated in accordance with wireless communication performed between the wireless communication unit 220 and the portable device 10 with the moving object V as a reference.

In this case, one feature of the control unit 210 according to the present embodiment is to cause the control target device to execute a predetermined operation in a case where the direction of the portable device is within a defined range.

The control target device according to the present embodiment may include, for example, a locking device for locking and unlocking a door, an engine, an accelerator, a brake, a steering device, and a lighting device provided in the moving object V.

For example, in a case where the direction of the portable device 10 is within the defined range, the control unit 210 according to the present embodiment may instruct the locking device to unlock the door.

For example, in a case where the direction of the portable device 10 is within the defined range, the control unit 210 according to the present embodiment may allow the engine to be started.

For example, in a case where the direction of the portable device 10 is within the defined range, the control unit 210 according to the present embodiment may perform control such that the moving object V is automatically parked at a parking space.

For example, in a case where the direction of the portable device 10 is within the defined range, the control unit 210 according to the present embodiment may assist a user in getting into the moving object V by lighting the lighting device provided in a lower part of the door of the moving object V.

According to the above control, it is possible to control various processes in accordance with a direction of the portable device 10 carried by a user and thus to increase convenience.

According to the above control, it is possible to improve the security with a simple configuration.

Another feature of the control unit 210 according to the present embodiment is to determine whether or not retry of wireless communication is necessary on the basis of a status in which a signal from the portable device 10 is received by the wireless communication unit 220.

The control unit 210 according to the present embodiment can more efficiently realize retry related to wireless communication by determining whether or not retry is necessary on the basis of a status in which at least two antenna elements 225 of the wireless communication unit 220 receive signals.

For example, in a case where it is determined that retry of the wireless communication is necessary, the control unit 210 according to the present embodiment may cause the wireless communication unit 220 to transmit a retry request related to the wireless communication to the portable device 10.

The retry request may be a signal used to estimate a direction of the portable device 10, that is, a signal for requesting retransmission of the first signal in a case where a state of the portable device 10 has transitioned to a defined state appropriate for wireless communication.

According to the retry request transmission control, it is possible to request the portable device 10 to retransmit the first signal in a status in which retry is actually necessary such that execution of unnecessary retry can be avoided, and thus to realize efficient retry.

The control unit 210 according to the present embodiment may determine whether or not retry of wireless communication is necessary, for example, on the basis of a channel impulse response (CIR) that is estimated from a signal (for example, the first signal) from the portable device 10 received by each of at least two antenna elements 225.

For example, the control unit 210 according to the present embodiment may determine whether or not retry of wireless communication is necessary on the basis of a first pass in an estimated CIR.

Here, the first pass refers to a signal that is transmitted from the portable device 10 and is directly received by the antenna element 225 without being reflected at other objects.

For example, the control unit 210 may detect peaks in a time series in a CIR and regard, as the first pass, a signal related to a peak that has an intensity that exceeds a threshold value for the first time in the time series.

Typically, in an environment in which a communication status is stable and which is not influenced by multiple passes, first passes related to each of two or more antenna elements 225 can be expected to show similar characteristics.

From this, the control unit 210 according to the present embodiment may determine that retry of wireless communication is necessary in a case where the first pass related to any antenna element 225 is estimated to be attenuated.

For example, in a case where a first pass related to any antenna element 225 cannot be detected, the control unit 210 may estimate the first pass to be attenuated and thus determine that retry of wireless communication is necessary.

For example, in a case where there is a notable time difference between detected first passes related to the antenna elements 225, there is a probability that multiple passes may be wrongly detected as a first pass due to attenuation of an original first pass. Thus, in a case where there is a notable time difference between the detected first passes, the control unit 210 may determine that retry of wireless communication is necessary.

For example, in a case where it is difficult to estimate a CIR, the control unit 210 may determine that retry of wireless communication is necessary.

According to such a determination based on a CIR, it is possible to determine whether or not retry of wireless communication is necessary with higher accuracy such that execution of unnecessary retry can be avoided, and thus to realize efficient retry.

### Wireless Communication Unit 220

The wireless communication unit 220 according to the present embodiment performs wireless communication with the portable device 10. For example, the wireless communication unit 220 may receive the first signal from the portable device 10 and transmit the second signal as a response to the first signal. For example, the wireless communication unit 220 may receive distance measurement information such as a distance measurement value from the portable device 10.

The wireless communication unit 220 according to the present embodiment includes at least two antenna elements 225a and 225b. The wireless communication unit 220 may estimate an angle of arrival (AoA) of signals on the basis of a phase difference between the signals from the portable device 10 received by the antenna elements 225a and 225b.

In this case, the control unit 210 may control a control target device on the basis of the angle of arrival estimated by the wireless communication unit 220. Specifically, in a case where the angle of arrival is within a defined range, the control unit 210 may cause the control target device to perform a predetermined operation.

According to the above control, it is possible to perform control in accordance with a direction of the portable device 10 with a simple configuration including at least two antenna elements 225a and 225b such that power consumption can be reduced while ensuring the security.

As above, the functional configuration example of the in-vehicle device according to the present embodiment has been described. The above-described functional configuration of the in-vehicle device 20 is only an example, and the functional configuration of the in-vehicle device 20 according to the present embodiment is not limited to such an example. The functional configuration of the in-vehicle device 20 according to the present embodiment may be flexibly modified according to a specification or an operation.

### 1.2. Control for Control Target Device Based on Direction of Portable Device 10

Next, control for a control target device based on a direction of the portable device 10 according to the present embodiment will be described in detail.

In the related art, as means for performing authentication of a portable device, signals in a low frequency (LF) band an ultra high frequency (UHF) band are widely used. However, in a case where a signal in the LF band or the UHF band is used, a countermeasure for a relay attack or the like of establishing illegal authentication by relaying a signal of a portable device is necessary in order to ensure the security.

As the countermeasure, for example, a method of performing distance measurement between an in-vehicle device and a portable device and performing authentication based on a calculated distance measurement value is supposed.

However, it is necessary to acquire a highly accurate distance measurement value in order to perform accurate authentication based on the distance measurement value.

As a method of acquiring a highly accurate distance measurement value, for example, it is supposed that a plurality of communication units for acquiring distance measurement values may be mounted in a vehicle, and distance measurement may be performed for each communication unit. However, in this case, manufacturing cost is increased as the number of communication units mounted in a vehicle is increased.

As another method, a plurality of distance measurements are supposed to be performed with a single communication unit. However, even in this case, power consumption is increased as the number of distance measurements is increased.

Thus, the control unit 210 of the in-vehicle device 20 according to the present embodiment may estimate an angle of arrival of a signal transmitted from the portable device 10, and cause a control target device to perform a predetermined operation in a case where the angle of arrival is within a predetermined range and a direction of the portable device 10 is within a predetermined range.

According to the above control, it is possible to eliminate concern about a relay attack and prevent an increase in power consumption due to a plurality of distance measurements.

In addition to the control based on a direction of the portable device 10, the control unit 210 of the in-vehicle device 20 according to the present embodiment may cause the control target device to perform the predetermined operation in a case where a distance between the portable device 10 and the in-vehicle device 20, estimated on the basis of wireless communication, is within a defined range.

In other words, in a case where the estimated angle of arrival is within a defined range and the distance measurement value is within a defined range, the control unit 210 may cause the control target device to perform the predetermined operation.

According to the control, it is possible to perform more secure authentication on the basis of a direction and a distance of the portable device 10 and also to provide a more detailed function according to the direction and the distance.

A signal used to calculate an angle of arrival and to measure a distance may be a signal using the above-described UWB frequency. In this case, the wireless communication unit 220 can estimate an angle of arrival of the first signal by receiving the first signal transmitted from the portable device 10 with the antenna elements 225a and 225b in order to measure a distance, and can thus realize the above control with a smaller number of times of communication.

On the other hand, signals based on different wireless communication standards may be used to calculate an angle of arrival and to measure a distance. According to this, for example, in a case where the portable device 10 is a smartphone, it is possible to perform the above control by using Wi-Fi (registered trademark) or Bluetooth (registered trademark) that is available for the smartphone.

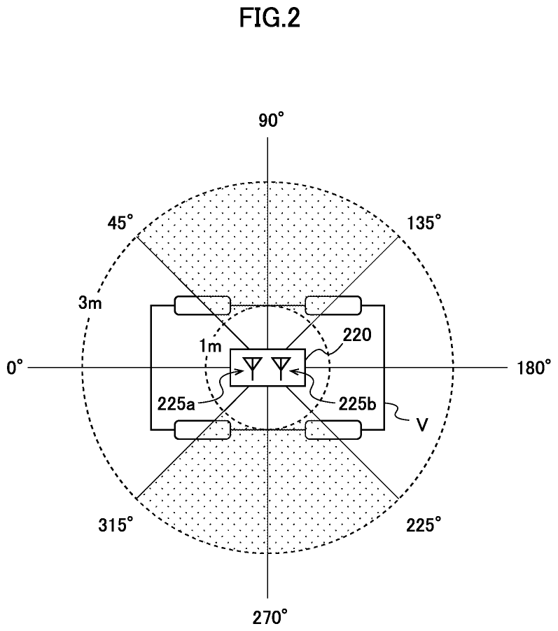

Hereinafter, control for a control target device performed by the in-vehicle device 20 according to the present embodiment will be described by using a specific example. FIG. 2 is a diagram for describing an example of control for a control target device in the in-vehicle device 20 according to the present embodiment.

FIG. 2 illustrates the moving object V and a disposition example of the two antenna elements 225a and 225b of the wireless communication unit 220 mounted in the moving object V.

As illustrated in FIG. 2, the antenna elements 225a and 225b according to the present embodiment may be disposed with a defined gap according to an advancing direction of the moving object V around the center of the moving object V. In FIG. 2, the advancing direction of the moving object V is indicated by 0°.

According to such disposition, the two antenna elements 225a and 225b are used to accurately estimate an angle of the portable device 10 present on lateral sides of the moving object V, that is, near the doors of s driver seat, a passenger seat, and a rear seat, and thus it is possible to effectively provide a function according to the angle of the portable device 10 to a user who intends to get in the moving object V.

In FIG. 2, a condition in which the control unit 210 of the in-vehicle device 20 causes a control target device to execute a predetermined operation is visually indicated by a dot background.

For example, as illustrated in FIG. 2, the control unit 210 according to the present embodiment may cause a control target device to execute a predetermined operation in a case where an estimated angle of arrival (that is, a direction of the portable device 10 with the moving object V as a reference) is in a range of 45° to 135° or 225° to 315°, and an acquired distance measurement value is in a range of 1 m to 3 m.

According to such control, it is possible to finely restrict a position (a direction and a distance) of the portable device 10 as a condition for causing the control target device to perform a predetermined operation and thus to increase the security and also to provide various functions appropriate for the position to a user.

As above, the control for a control target device based on a direction of the portable device 10 according to the present embodiment has been described by using the specific example. The above-described defined range is only an example, and the defined range according to the present embodiment may be flexibly modified according to a specification or an operation.

As described above, in the above-described control for a control target device, the system 1 according to the present embodiment determines whether or not retry of wireless communication is necessary with high accuracy and thus realizes efficient retry while avoiding unnecessary retry.

Hereinafter, a flow of the retry control will be described in detail.

### 1.3. Flow of Process

Prior to description of a flow of the retry control according to the present embodiment, first, a flow of control for a control target device in the system 1 will be described.

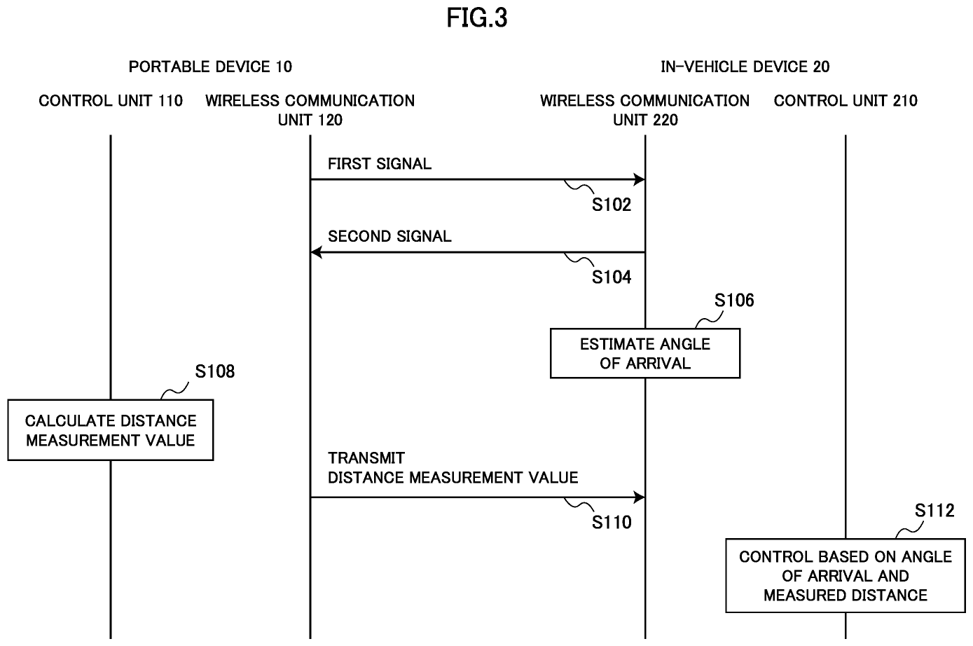

FIG. 3 is a sequence diagram illustrating an example of a flow of control for a control target device in the system 1 according to the present embodiment.

In a case of an example illustrated in FIG. 3, first, the wireless communication unit 120 of the portable device 10 transmits the first signal (S102). The first signal is used to measure a distance and to estimate an angle of arrival.

The first signal is received by the two or more antenna elements 225 included in the wireless communication unit 220 of the in-vehicle device 20.

Next, the wireless communication unit 220 of the in-vehicle device 20 transmits the second signal as a response to the first signal received in step S102 (S104). The second signal is used to measure a distance.

The wireless communication unit 220 of the in-vehicle device 20 estimates an angle of arrival on the basis of a phase difference related to the first signal received by the at least two antenna elements 225 in step S102 (S106).

On the other hand, the control unit 110 of the portable device 10 performs distance measurement based on the first signal transmitted from the wireless communication unit 120 in step S102 and the second signal received by the wireless communication unit 120 in step S104, and thus calculates a distance measurement value (S108).

Next, the wireless communication unit 120 transmits the distance measurement value calculated in step S108 to the wireless communication unit 220 (S110).

Next, the control unit 210 of the in-vehicle device 20 executes control based on the angle of arrival estimated in step S106 and the distance measurement value received in step S110 (S112).

As above, the example of the flow of control for a control target device according to the present embodiment has been described. The above-described flow is only an example, and a process performed by the system 1 is not limited to such an example.

For example, in the above description, a case where the control unit 110 of the portable device 10 calculates a distance measurement value has been exemplified, but the control unit 210 of the in-vehicle device 20 may calculate a distance measurement value according to the present embodiment.

In this case, for example, the wireless communication unit 120 of the portable device 10 may transmit information (for example, the above ΔT1) for calculating a distance measurement value to the wireless communication unit 220. The wireless communication unit 220 may transmit the first signal, and the wireless communication unit 120 may transmit the second signal as a response to the first signal.

For example, the wireless communication unit 120 of the portable device 10 may estimate a direction of the portable device 10 with the moving object V as a reference. In this case, the wireless communication unit 220 of the in-vehicle device 20 may transmit information (for example, a phase difference or various information for acquiring the phase difference) for estimating the direction to the wireless communication unit 120. The wireless communication unit 120 returns information regarding the estimated direction to the wireless communication unit 220.

As described above, the flow of control for a control target device according to the present embodiment may be flexibly modified.

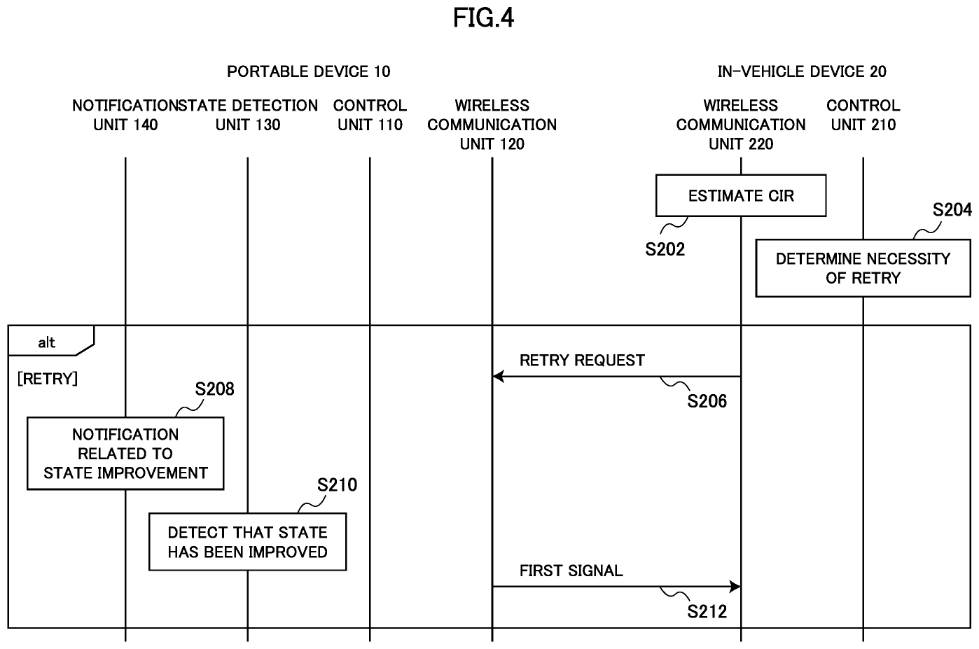

Next, a flow of retry control for wireless communication according to the present embodiment will be described in detail. FIG. 4 is a sequence diagram illustrating an example of a flow of retry control in the system 1 according to the present embodiment.

FIG. 4 illustrates an example of a case where it is determined whether or not retry is necessary in association with estimation of an angle of arrival in step S106 after the first signal is received in step S102 illustrated in FIG. 3.

In this case, first, the wireless communication unit 220 of the in-vehicle device 20 estimates a CIR related to the first signal received by each antenna element 225 (S202).

Next, the control unit 210 of the in-vehicle device 20 determines whether or not retry of wireless communication is necessary on the basis of the CIR estimated in step S202 (S204).

In this case, the control unit 210 may determine whether or not retry of wireless communication is necessary on the basis of the above-described first pass.

In a case where it is determined that retry of wireless communication is necessary in step S204, the control unit 210 causes the wireless communication unit 220 to transmit a retry request (S206).

When the wireless communication unit 120 of the portable device 10 receives the retry request in step S206, the control unit 110 of the portable device 10 causes the notification unit 140 to output a notification for prompting state improvement of the portable device 10 (S208).

The control unit 110 causes the state detection unit 130 to monitor a state of the portable device 10.

Thereafter, in a case where the state detection unit 130 detects that the state of the portable device 10 has been improved, that is, the portable device 10 has transitioned to a defined state appropriate for wireless communication (S210), the control unit 110 causes the wireless communication unit 120 to retransmit the first signal (S212).

As above, the flow of retry control for wireless communication according to the present embodiment has been described by using the example. The above-described flow is only an example, and a process performed by the system 1 is not limited to such an example.

For example, in the above description, a case where the control unit 210 of the in-vehicle device 20 determines whether or not retry of wireless communication is necessary on the basis of a CIR has been exemplified. On the other hand, the control unit 210 according to the present embodiment may determine whether or not retry of wireless communication is necessary on the basis of, for example, a received signal strength indicator (RSSI) of the first signal related to each of the antenna elements 225.

In this case, for example, when an RSSI related to any antenna element 225 is less than a certain threshold value, the control unit 210 may determine that retry is necessary.

In the above description, a case where the control unit 210 of the in-vehicle device 20 determines whether or not retry of wireless communication is necessary has been exemplified. On the other hand, whether or not retry of wireless communication is necessary may be determined by the control unit 110 of the portable device 10, and may be determined by both of the control unit 110 of the portable device 10 and the control unit 210 of the in-vehicle device 20.

In this case, for example, the control unit 110 of the portable device 10 may determine whether or not retry of wireless communication device is necessary on the basis of a CIR related to the second signal received by the antenna element 125.

As described above, the flow of retry control for wireless communication according to the present embodiment may be flexibly modified.

### 2. Appendix

Heretofore, preferred embodiments of the present invention have been described in detail with reference to the appended drawings, but the present invention is not limited thereto. It should be understood by those skilled in the art that various changes and alterations may be made without departing from the spirit and scope of the appended claims.

A series of processes performed by each device described in the present specification may be realized by using any of software, hardware, and a combination of the software and the hardware. A program configuring the software is stored in advance in, for example, a non-transitory storage medium provided inside or outside each device. Each program is read to a RAM, for example, when the program is executed by a computer, and is executed by a processor such as a CPU. The recording medium is, for example, a magnetic disk, an optical disc, a magnetooptical disc, or a flash memory. The computer program may be distributed via, for example, a network instead of using the recording medium.

What is claimed is:

1. A control device comprising:
a wireless communication unit that has at least two antenna elements and performs wireless communication with another communication device; and
a control unit that controls a control target device on the basis of a direction of the other communication device that is estimated by using the wireless communication,
wherein the control unit determines whether or not retry of the wireless communication is necessary on the basis of a status in which the wireless communication unit receives a signal from the other communication device.

2. The control device according to claim 1,
wherein, in a case where it is determined that the retry of the wireless communication is necessary, the control unit causes the wireless communication unit to transmit a retry request related to the wireless communication to the other communication device.

3. The control device according to claim 2,
wherein the retry request is a request for retransmission of a signal used to estimate a direction of the other communication device in a case where a state of the other communication device has transitioned to a defined state appropriate for the wireless communication.

4. The control device according to claim 1,
wherein the control unit determines whether or not the retry of the wireless communication is necessary on the basis of a channel impulse response estimated by using a signal from the other communication device, received by each of the at least two antenna elements.

5. The control device according to claim 4,
wherein the control unit determines whether or not the retry of the wireless communication is necessary on the basis of a first pass in the estimated channel impulse response.

6. The control device according to claim 5,
wherein the control unit determines that the retry of the wireless communication is necessary in a case where attenuation of the first pass is estimated.

7. The control device according to claim 1, mounted in a moving object.

8. The control device according to claim 7,
wherein the at least two antenna elements are disposed around a center of the moving object.

9. The control device according to claim 1,
wherein the wireless communication unit performs ultra-wide band wireless communication with the other communication device.

10. A communication device that is carried by a user and performs wireless communication with another device, the communication device comprising:
a wireless communication unit that performs the wireless communication;
a state detection unit that detects a state of the communication device;
a notification unit that provides a notification to the user; and
a control unit that controls retry of the wireless communication on the basis of a retry request transmitted from the other device,
wherein the control unit
causes the notification unit to output a notification for prompting the user to improve a state of the communication device in a case where the wireless communication unit has received the retry request, and
instructs the wireless communication unit to retry the wireless communication in a case where the state detection unit detects that the state of the communication device has transitioned to a defined state appropriate for the wireless communication.

11. A system comprising:
a control device; and
a communication device,
wherein the control device includes
a first wireless communication unit that has at least two antenna elements and performs wireless communication with the communication device, and
a first control unit that controls a control target device on the basis of a direction of the communication device that is estimated by using the wireless communication,
wherein the first control unit determines whether or not retry of the wireless communication is necessary on the basis of a status in which the first wireless communication unit receives a signal from the communication device,
wherein the communication device includes
a second wireless communication unit that performs the wireless communication with the control device,
a state detection unit that detects a state of the communication device,
a notification unit that provides a notification to a user, and
a second control unit that controls retry of the wireless communication on the basis of a retry request transmitted from the control device, and
wherein the second control unit
causes the notification unit to output a notification for prompting the user to improve a state of the communication device in a case where the second wireless communication unit has received the retry request, and
instructs the second wireless communication unit to retry the wireless communication in a case where the state detection unit detects that the state of the communication device has transitioned to a defined state appropriate for the wireless communication.
